(19) United States
(12) Patent Application Publication
(10) Pub. No.: US 2026/0357048 A1
(43) Pub. Date: Nov. 12, 2026

(54) PUNCTURE-RESISTANT AND TEAR-RESISTANT WATERPROOF SHEET AND PREPARATION METHOD THEREOF

(71) Applicant: HEBEI TIEKE YICHEN NEW MATERIALS TECHNOLOGY CORPORATION LIMITED, Shijiazhuang (CN)

(72) Inventors: Quanxiao DONG, Shijiazhuang (CN); Weibin MA, Shijiazhuang (CN); Yubao GUO, Shijiazhuang (CN); Jie CHANG, Shijiazhuang (CN); Ziheng CHANG, Shijiazhuang (CN); Songsong MA, Shijiazhuang (CN); Peng QIU, Shijiazhuang (CN); Dezhu TIAN, Shijiazhuang (CN); Xianggang DU, Shijiazhuang (CN); Ling ZHANG, Shijiazhuang (CN); Weihua ZHANG, Shijiazhuang (CN); Xingxu BAO, Shijiazhuang (CN); Xiaoxiong GUO, Shijiazhuang (CN); Jiaqi HAO, Shijiazhuang (CN); Zhiwei LI, Shijiazhuang (CN); Xuhao TANG, Shijiazhuang (CN); Tiantian SONG, Shijiazhuang (CN); Zefu ZHENG, Shijiazhuang (CN); Guoqiang HAO, Shijiazhuang (CN); Kaiming ZHANG, Shijiazhuang (CN); Linheng BAO, Shijiazhuang (CN)

(73) Assignee: HEBEI TIEKE YICHEN NEW MATERIALS TECHNOLOGY CORPORATION LIMITED, Shijiazhuang (CN)

(21) Appl. No.: 19/720,799

(22) Filed: Jun. 25, 2026

Related U.S. Application Data
(63) Continuation of application No. PCT/CN2025/138335, filed on Nov. 28, 2025.

(30) Foreign Application Priority Data
Dec. 2, 2024 (CN) 2024117511703

(51) Int. Cl. C08L 23/06; C08J 3/22; C08J 5/18; C08K 5/13; C08K 5/524; C08K 5/526; C08L 23/0853; C08L 23/26

(52) U.S. Cl. CPC C08L 23/06; C08J 3/226; C08J 5/18; C08K 5/13; C08K 5/524; C08K 5/526; C08L 23/0853; C08L 23/26; C08J 2323/06; C08J 2323/08; C08J 2323/26; C08J 2423/06; C08J 2423/08; C08J 2423/26; C08J 2451/00; C08L 2201/08; C08L 2205/025; C08L 2205/035; C08L 2205/08; C08L 2207/068; C08L 2310/00

(57) ABSTRACT

The present application relates to the technical field of waterproof materials for railway tunnels, and more particularly, to a puncture-resistant and tear-resistant waterproof sheet and a preparation method thereof. The waterproof sheet is prepared by uniformly mixing a plurality of raw materials and then processing the mixture through a counter-rotating twin-screw extruder and cooling calender rolls. The raw materials of the waterproof sheet include, in parts by weight, 15 to 35 parts of an ethylene-vinyl acetate copolymer, 20 to 40 parts of an ultra-high molecular weight polyethylene, 20 to 30 parts of a modified polypropylene, 10 to 25 parts of an ethylene-octene copolymer, 3 to 5 parts of silica particles, 3 to 5 parts of a compatibilizer, and 3 to 5 parts of an antioxidant masterbatch. The waterproof sheet has excellent puncture resistance and tear resistance.

### CROSS-REFERENCE TO RELATED APPLICATIONS

The application claims priority to Chinese patent application No. 2024117511703, filed on Dec. 2, 2024, the entire contents of which are incorporated herein by reference.

### TECHNICAL FIELD

The present application relates to the technical field of waterproof materials for railway tunnels, and more particularly, to a puncture-resistant and tear-resistant waterproof sheet and a preparation method thereof.

### BACKGROUND

With the rapid development of China's economy, the modernization of road construction has reached a new level. Due to the complex terrain in China, traffic tunnels have become an important part of road construction, among which railway tunnels and urban rail transit account for a significant proportion of traffic tunnels. Railway tunnels are underground structures that inevitably face various complex geological conditions, such as developed groundwater, frost-heaving rocks, and high-temperature thermal hazards from rocks in tunnels. Among these, high-temperature thermal hazards from rocks in tunnels, as one of the hazards to tunnels, directly affect train operation safety, which requires waterproof sheets to have excellent high-temperature puncture resistance.

At present, the development of waterproof materials in the market is relatively slow and can no longer solve the complex problems encountered in tunnel engineering. Upgrading waterproof materials has thus become one of the important directions in tunnel engineering.

### SUMMARY

A technical problem to be solved by the present application is to provide a puncture-resistant and tear-resistant waterproof sheet and a preparation method thereof.

In one aspect, the present application provides a puncture-resistant and tear-resistant waterproof sheet, where the waterproof sheet is prepared by uniformly mixing various raw materials and then processing the mixture through a counter-rotating twin-screw extruder and cooling calender rolls;

the raw materials for the waterproof sheet comprise, in parts by weight, 15 to 35 parts of an ethylene-vinyl acetate copolymer, 20 to 40 parts of an ultra-high molecular weight polyethylene, 20 to 30 parts of a modified polypropylene, 10 to 25 parts of an ethylene-octene copolymer, 3 to 5 parts of silica particles, 3 to 5 parts of a compatibilizer, and 3 to 5 parts of an antioxidant masterbatch.

As an embodiment of the present application, the ethylene-vinyl acetate copolymer has a vinyl acetate content of 15 wt % to 35 wt % and a melt flow rate of 5.8 to 6.5 g/10 min measured at 190 °C under a 2.16 kg load; the ultra-high molecular weight polyethylene has a density of 0.920 to 0.969 g/cm³.

As an embodiment of the present application, the modified polypropylene is a modified polypropylene comprising styrene-butadiene-styrene block copolymer segments; the silica particles have a particle diameter of 10 to 30 μm; the compatibilizer is a maleic anhydride grafted compatibilizer or a carboxylic acid type compatibilizer.

As an embodiment of the present application, the ethylene-octene copolymer has a density of 0.901 to 0.920 g/cm³ and a melt flow rate of 0.80 to 1.10 g/10 min measured at 190 °C under a 2.16 kg load.

As an embodiment of the present application, the raw materials of the antioxidant masterbatch include, in parts by weight, 50 to 70 parts of a linear low-density polyethylene, 20 to 30 parts of an antioxidant, and 10 to 20 parts of a light stabilizer;

the linear low-density polyethylene has a density of 0.918 to 0.923 g/cm³ and a melt flow rate of 0.60 to 1.30 g/10 min measured at 190 °C under a 2.16 kg load;

the light stabilizer is a hindered amine light stabilizer; the antioxidant is a mixture of a phenolic antioxidant and a phosphite antioxidant in a weight ratio of 1:2, the phenolic antioxidant is antioxidant 1010 or antioxidant 2246; the phosphite antioxidant is selected from one or both of tris(2,4-di-tert-butylphenyl) phosphite and distearyl pentaerythritol diphosphite.

In another aspect, the present application provides a preparation method for the above-described puncture-resistant and tear-resistant waterproof sheet, where the method includes:
Step S1: Adding an antioxidant, a light stabilizer, and a linear low-density polyethylene into a high-speed mixer, and stirring the mixture at 25±5 °C to prepare an antioxidant premix, wherein the antioxidant is a mixture of a phenolic antioxidant and a phosphite antioxidant in a weight ratio of 1:2;
Step S2: Processing the antioxidant premix through an underwater pelletizer to prepare an antioxidant masterbatch;
Step S3: Adding the antioxidant masterbatch, an ethylene-vinyl acetate copolymer, an ultra-high molecular weight polyethylene, a modified polypropylene, an ethylene-octene copolymer, silica particles, and a compatibilizer into a mixer, and mixing uniformly to prepare a sheet premix;
Step S4: Processing the sheet premix through a counter-rotating twin-screw extruder and cooling calender rolls to achieve continuous production of a 4 m wide puncture-resistant and tear-resistant waterproof sheet at a rate of 3.7 to 4.3 m/min.

As an embodiment of the present application, in Step S1, the antioxidant, the light stabilizer, and the linear low-density polyethylene are mixed in the high-speed mixer for 5 min.

As an embodiment of the present application, in Step S2, the antioxidant premix is subjected to melt blending in an underwater pelletizer, the melt extrusion temperature is 190 to 200 °C, and the rotation speed is 200 to 350 rpm; the melt extrusion equipment is a counter-rotating twin-screw extruder.

As an embodiment of the present application, in Step S3, the antioxidant masterbatch, the ethylene-vinyl acetate copolymer, the ultra-high molecular weight polyethylene, the modified polypropylene, the ethylene-octene copolymer, the silica particles, and the compatibilizer are mixed in the high-speed mixer for 10 min.

As an embodiment of the present application, in Step S4, the counter-rotating twin-screw extruder has an operating temperature of 200 to 220 °C and a screw rotation speed of 300 rpm;

the cooling calender rolls have a roll temperature of 55±5 °C and a roll diameter of 600 mm.

Compared with the prior art, the present application has the following beneficial effects:

In the composition of the puncture-resistant and tear-resistant waterproof sheet of the present application, the ultra-high molecular weight polyethylene imparts high tensile strength to the waterproof sheet, the modified polypropylene imparts high puncture resistance to the waterproof sheet, the ethylene-octene copolymer imparts high tear strength to the waterproof sheet, and the silica particles and compatibilizer can effectively enhance the intermolecular connections, thereby effectively improving all properties of the waterproof sheet. The antioxidant masterbatch can greatly delay the oxidation of the waterproof sheet. The vinyl acetate content in the waterproof sheet is not less than 5%, which effectively ensures the weldability of the waterproof sheet and facilitates subsequent use.

By reasonably adjusting the weight ratio of each component in the composition, appropriate interactions between the components are obtained, and the synergistic effect among the components is maximized, so that the 4 m wide puncture-resistant and tear-resistant waterproof sheet can be produced continuously at a high speed of up to 4.3 m/min, while ensuring that the waterproof sheet has significantly better tensile properties and puncture resistance.

### DETAILED DESCRIPTION OF THE EMBODIMENTS

To make the objectives, technical solutions and advantages of the present application clearer, the present application will be described clearly and completely below in conjunction with specific embodiments.

Unless otherwise specified, various raw materials, reagents, instruments and equipment used in the present application are available from the market or prepared by existing methods.

### Example 1

A puncture-resistant and tear-resistant waterproof sheet, the preparation method thereof includes:
Step S1: Adding 70 parts of a linear low-density polyethylene, 20 parts of an antioxidant and 10 parts of a light stabilizer into a high-speed mixer, mixing for 5 min, and stirring at 20 °C to prepare an antioxidant premix;
where the linear low-density polyethylene is Saudi SABIC 118W, having a density of 0.918 g/cm³ and a melt flow rate of 1.0 g/10 min measured at 190 °C under a 2.16 kg load; the antioxidant is a mixture of antioxidant 1010 and distearyl pentaerythritol diphosphite in a weight ratio of 1:2; the light stabilizer is hindered amine light stabilizer 770;
Step S2: Processing the antioxidant premix through an underwater pelletizer to prepare an antioxidant masterbatch, with a melt extrusion temperature of 190 °C and a rotation speed of 350 rpm;
Step S3: Adding 15 parts of an ethylene-vinyl acetate copolymer, 20 parts of an ultra-high molecular weight polyethylene, 20 parts of a modified polypropylene, 10 parts of an ethylene-octene copolymer (POE), 3 parts of silica particles, 3 parts of a maleic anhydride grafted compatibilizer, and 3 parts of an antioxidant masterbatch into a mixer, mixing for 10 min until uniform to prepare a sheet premix;
where the ethylene-vinyl acetate copolymer has a vinyl acetate content of 28 wt % and a melt flow rate of 6.2 g/10 min measured at 190 °C under a 2.16 kg load; the ultra-high molecular weight polyethylene is L3000, having a density of 0.969 g/cm³; the silica particles have a particle diameter of 20 μm; the ethylene-octene copolymer (POE) has a density of 0.904 g/cm³ and a melt flow rate of 1.0 g/10 min measured at 190 °C under a 2.16 kg load;
the modified polypropylene is modified PP pellets, prepared by the method disclosed in Chinese Patent Publication No. CN113667419A, with the same composition as that of the intermediate layer in Example 2 of the patent; the raw material composition by weight is 100 parts of polypropylene, 10 parts of styrene-butadiene-styrene block copolymer and 0.13 parts of dicumyl peroxide, which is produced by a one-step grafting blending method through high-temperature extrusion.
Step S4: Processing the sheet premix through a counter-rotating twin-screw extruder and cooling calender rolls to prepare a 4 m wide puncture-resistant and tear-resistant waterproof sheet, with an extruder operating temperature of 200 °C and a screw rotation speed of 300 rpm; the cooling calender rolls have a roll temperature of 50 °C and a roll diameter of 600 mm.

### Example 2

A puncture-resistant and tear-resistant waterproof sheet, the preparation method thereof includes:
Step S1: Adding 60 parts of a linear low-density polyethylene, 25 parts of an antioxidant and 15 parts of a light stabilizer into a high-speed mixer, mixing for 5 min, and stirring at 25 °C to prepare an antioxidant premix;
the antioxidant is a mixture of a phenolic antioxidant and a phosphite antioxidant in a weight ratio of 1:2, the phenolic antioxidant is antioxidant 2246, and the phosphite antioxidant is a mixture of tris(2,4-di-tert-butylphenyl) phosphite and distearyl pentaerythritol diphosphite; the linear low-density polyethylene and light stabilizer are the same as those in Example 1;
Step S2: Processing the antioxidant premix through an underwater pelletizer to prepare an antioxidant masterbatch, with a melt extrusion temperature of 195 °C and a rotation speed of 300 rpm;
Step S3: Adding 23 parts of an ethylene-vinyl acetate copolymer, 31 parts of an ultra-high molecular weight polyethylene, 24 parts of a modified polypropylene, 16 parts of an ethylene-octene copolymer, 4 parts of silica particles, 4 parts of a carboxylic acid type compatibilizer, and 4 parts of an antioxidant masterbatch into a mixer, mixing for 10 min until uniform to prepare a sheet premix; where, except for the compatibilizer and antioxidant masterbatch, the rest are the same as those in Example 1;
Step S4: Processing the sheet premix through a counter-rotating twin-screw extruder and cooling calender rolls to prepare a 4 m wide puncture-resistant and tear-resistant waterproof sheet, with an extruder operating temperature of 210 °C and a screw rotation speed of 300 rpm; the cooling calender rolls have a roll temperature of 55 °C and a roll diameter of 600 mm.

### Example 3

A puncture-resistant and tear-resistant waterproof sheet, the preparation method thereof includes:
Step S1: Adding 50 parts of a linear low-density polyethylene, 30 parts of an antioxidant and 20 parts of a light stabilizer into a high-speed mixer, mixing for 5 min, and stirring at 30 °C to prepare an antioxidant premix;
where the antioxidant is a mixture of antioxidant 2246 and tris(2,4-di-tert-butylphenyl) phosphite in a weight ratio of 1:2; the linear low-density polyethylene and light stabilizer are the same as those in Example 1;
Step S2: Processing the antioxidant premix through an underwater pelletizer to prepare an antioxidant masterbatch, with a melt extrusion temperature of 200 °C and a rotation speed of 200 rpm;
Step S3: Adding 35 parts of an ethylene-vinyl acetate copolymer, 40 parts of an ultra-high molecular weight polyethylene, 30 parts of a modified polypropylene, 25 parts of an ethylene-octene copolymer, 5 parts of silica particles, 5 parts of a carboxylic acid type compatibilizer, and 5 parts of an antioxidant masterbatch into a mixer, mixing for 10 min until uniform to prepare a sheet premix; where, except for the compatibilizer and antioxidant masterbatch, the rest are the same as those in Example 1;
Step S4: Processing the sheet premix through a counter-rotating twin-screw extruder and cooling calender rolls to prepare a 4 m wide puncture-resistant and tear-resistant waterproof sheet, with an extruder operating temperature of 200 °C and a screw rotation speed of 300 rpm; the cooling calender rolls have a roll temperature of 60 °C and a roll diameter of 600 mm.

### Example 4

A puncture-resistant and tear-resistant waterproof sheet, the preparation method thereof includes:
Step S1: Adding 55 parts of a linear low-density polyethylene, 22 parts of an antioxidant and 26 parts of a light stabilizer into a high-speed mixer, mixing for 5 min, and stirring at 27 °C to prepare an antioxidant premix;
the antioxidant is a mixture of a phenolic antioxidant and a phosphite antioxidant in a weight ratio of 1:2, the phenolic antioxidant is antioxidant 2246, and the phosphite antioxidant is tris(2,4-di-tert-butylphenyl) phosphite; the linear low-density polyethylene and light stabilizer are the same as those in Example 1;
Step S2: Processing the antioxidant premix through an underwater pelletizer to prepare an antioxidant masterbatch, with a melt extrusion temperature of 193 °C and a rotation speed of 300 rpm;
Step S3: Adding 18 parts of an ethylene-vinyl acetate copolymer, 22 parts of an ultra-high molecular weight polyethylene, 23 parts of a modified polypropylene, 13 parts of an ethylene-octene copolymer, 3 parts of silica particles, 4 parts of a carboxylic acid type compatibilizer, and 5 parts of an antioxidant masterbatch into a mixer, mixing for 10 min until uniform to prepare a sheet premix; where, except for the compatibilizer and antioxidant masterbatch, the rest are the same as those in Example 1;
Step S4: Processing the sheet premix through a counter-rotating twin-screw extruder and cooling calender rolls to prepare a 4 m wide puncture-resistant and tear-resistant waterproof sheet, with an extruder operating temperature of 208 °C and a screw rotation speed of 300 rpm; the cooling calender rolls have a roll temperature of 55 °C and a roll diameter of 600 mm.

### Example 5

A puncture-resistant and tear-resistant waterproof sheet, the preparation method thereof includes:
Step S1: Adding 58 parts of a linear low-density polyethylene, 26 parts of an antioxidant and 13 parts of a light stabilizer into a high-speed mixer, mixing for 5 min, and stirring at 25 °C to prepare an antioxidant premix;
the antioxidant is a mixture of a phenolic antioxidant and a phosphite antioxidant in a weight ratio of 1:2, the phenolic antioxidant is antioxidant 2246, and the phosphite antioxidant is distearyl pentaerythritol diphosphite; the linear low-density polyethylene and light stabilizer are the same as those in Example 1;
Step S2: Processing the antioxidant premix through an underwater pelletizer to prepare an antioxidant masterbatch, with a melt extrusion temperature of 200 °C and a rotation speed of 320 rpm;
Step S3: Adding 20 parts of an ethylene-vinyl acetate copolymer, 35 parts of an ultra-high molecular weight polyethylene, 27 parts of a modified polypropylene, 17 parts of an ethylene-octene copolymer, 4 parts of silica particles, 3 parts of a carboxylic acid type compatibilizer, and 5 parts of an antioxidant masterbatch into a mixer, mixing for 10 min until uniform to prepare a sheet premix; where, except for the compatibilizer and antioxidant masterbatch, the rest are the same as those in Example 1;
Step S4: Processing the sheet premix through a counter-rotating twin-screw extruder and cooling calender rolls to prepare a 4 m wide puncture-resistant and tear-resistant waterproof sheet, with an extruder operating temperature of 215 °C and a screw rotation speed of 300 rpm; the cooling calender rolls have a roll temperature of 55 °C and a roll diameter of 600 mm.

### Example 6

A puncture-resistant and tear-resistant waterproof sheet, the preparation method thereof includes:
Step S1: Adding 62 parts of a linear low-density polyethylene, 29 parts of an antioxidant and 17 parts of a light stabilizer into a high-speed mixer, mixing for 5 min, and stirring at 26 °C to prepare an antioxidant premix;
the antioxidant is a mixture of a phenolic antioxidant and a phosphite antioxidant in a weight ratio of 1:2, the phenolic antioxidant is antioxidant 2246, and the phosphite antioxidant is a mixture of tris(2,4-di-tert-butylphenyl) phosphite and distearyl pentaerythritol diphosphite; the linear low-density polyethylene and light stabilizer are the same as those in Example 1;
Step S2: Processing the antioxidant premix through an underwater pelletizer to prepare an antioxidant masterbatch, with a melt extrusion temperature of 198 °C and a rotation speed of 310 rpm;
Step S3: Adding 30 parts of an ethylene-vinyl acetate copolymer, 29 parts of an ultra-high molecular weight polyethylene, 25 parts of a modified polypropylene, 22 parts of an ethylene-octene copolymer, 5 parts of silica particles, 3 parts of a carboxylic acid type compatibilizer, and 4 parts of an antioxidant masterbatch into a mixer, mixing for 10 min until uniform to prepare a sheet premix; where, except for the compatibilizer and antioxidant masterbatch, the rest are the same as those in Example 1;
Step S4: Processing the sheet premix through a counter-rotating twin-screw extruder and cooling calender rolls to prepare a 4 m wide puncture-resistant and tear-resistant waterproof sheet, with an extruder operating temperature of 220 °C and a screw rotation speed of 300 rpm; the cooling calender rolls have a roll temperature of 55 °C and a roll diameter of 600 mm.

### Example 7

A puncture-resistant and tear-resistant waterproof sheet, the preparation method thereof includes:
Step S1: Adding 70 parts of a linear low-density polyethylene, 20 parts of an antioxidant and 10 parts of a light stabilizer into a high-speed mixer, mixing for 5 min, and stirring at 20 °C to prepare an antioxidant premix;
where the linear low-density polyethylene has a density of 0.920 g/cm³ and a melt flow rate of 0.60 g/10 min measured at 190 °C under a 2.16 kg load; the antioxidant is a mixture of antioxidant 1010 and distearyl pentaerythritol diphosphite in a weight ratio of 1:2; the light stabilizer is hindered amine light stabilizer 770;
Step S2: Processing the antioxidant premix through an underwater pelletizer to prepare an antioxidant masterbatch, with a melt extrusion temperature of 190 °C and a rotation speed of 350 rpm;
Step S3: Adding 15 parts of an ethylene-vinyl acetate copolymer, 20 parts of an ultra-high molecular weight polyethylene, 20 parts of a modified polypropylene, 10 parts of an ethylene-octene copolymer (POE), 3 parts of silica particles, 3 parts of a maleic anhydride grafted compatibilizer, and 3 parts of an antioxidant masterbatch into a mixer, mixing for 10 min until uniform to prepare a sheet premix;
where the ethylene-vinyl acetate copolymer has a vinyl acetate content of 15 wt % and a melt flow rate of 5.8 g/10 min measured at 190 °C under a 2.16 kg load; the ultra-high molecular weight polyethylene has a density of 0.920 g/cm³; the silica particles have a particle diameter of 10 μm; the ethylene-octene copolymer has a density of 0.901 g/cm³ and a melt flow rate of 1.1 g/10 min measured at 190 °C under a 2.16 kg load; the modified polypropylene is the same as that in Example 1;
Step S4: Processing the sheet premix through a counter-rotating twin-screw extruder and cooling calender rolls to prepare a 4 m wide puncture-resistant and tear-resistant waterproof sheet, with an extruder operating temperature of 200 °C and a screw rotation speed of 300 rpm; the cooling calender rolls have a roll temperature of 50 °C and a roll diameter of 600 mm.

### Example 8

A puncture-resistant and tear-resistant waterproof sheet, the preparation method thereof includes:
Step S1: Adding 70 parts of a linear low-density polyethylene, 20 parts of an antioxidant and 10 parts of a light stabilizer into a high-speed mixer, mixing for 5 min, and stirring at 20 °C to prepare an antioxidant premix;
where the linear low-density polyethylene has a density of 0.923 g/cm³ and a melt flow rate of 1.30 g/10 min measured at 190 °C under a 2.16 kg load; the antioxidant is a mixture of antioxidant 1010 and distearyl pentaerythritol diphosphite in a weight ratio of 1:2; the light stabilizer is hindered amine light stabilizer 770;
Step S2: Processing the antioxidant premix through an underwater pelletizer to prepare an antioxidant masterbatch, with a melt extrusion temperature of 190 °C and a rotation speed of 350 rpm;
Step S3: Adding 15 parts of an ethylene-vinyl acetate copolymer, 20 parts of an ultra-high molecular weight polyethylene, 20 parts of a modified polypropylene, 10 parts of an ethylene-octene copolymer (POE), 3 parts of silica particles, 3 parts of a maleic anhydride grafted compatibilizer, and 3 parts of an antioxidant masterbatch into a mixer, mixing for 10 min until uniform to prepare a sheet premix;
where the ethylene-vinyl acetate copolymer has a vinyl acetate content of 35 wt % and a melt flow rate of 6.5 g/10 min measured at 190 °C under a 2.16 kg load; the ultra-high molecular weight polyethylene has a density of 0.940 g/cm³; the silica particles have a particle diameter of 30 μm; the ethylene-octene copolymer has a density of 0.901 g/cm³ and a melt flow rate of 0.80 g/10 min measured at 190 °C under a 2.16 kg load; the modified polypropylene is the same as that in Example 1;
Step S4: Processing the sheet premix through a counter-rotating twin-screw extruder and cooling calender rolls to prepare a 4 m wide puncture-resistant and tear-resistant waterproof sheet, with an extruder operating temperature of 200 °C and a screw rotation speed of 300 rpm; the cooling calender rolls have a roll temperature of 50 °C and a roll diameter of 600 mm.

### Comparative Example 1

A waterproof sheet, the preparation method thereof includes:
Step S1: Adding 60 parts of a linear low-density polyethylene, 25 parts of an antioxidant and 15 parts of a light stabilizer into a high-speed mixer, mixing for 5 min, and stirring at 25 °C to prepare an antioxidant premix;
the antioxidant is a mixture of a phenolic antioxidant and a phosphite antioxidant in a weight ratio of 1:2, the phenolic antioxidant is antioxidant 2246, and the phosphite antioxidant is a mixture of tris(2,4-di-tert-butylphenyl) phosphite and distearyl pentaerythritol diphosphite; the linear low-density polyethylene and light stabilizer are the same as those in Example 1;
Step S2: Processing the antioxidant premix through an underwater pelletizer to prepare an antioxidant masterbatch, with a melt extrusion temperature of 195 °C and a rotation speed of 300 rpm;
Step S3: Adding 23 parts of an ethylene-vinyl acetate copolymer, 31 parts of an ultra-high molecular weight polyethylene, 16 parts of an ethylene-octene copolymer, 4 parts of silica particles, 4 parts of a carboxylic acid type compatibilizer, and 4 parts of an antioxidant masterbatch into a mixer, mixing for 10 min until uniform to prepare a sheet premix; where, except for the compatibilizer and antioxidant masterbatch, the rest are the same as those in Example 1;
Step S4: Processing the sheet premix through a counter-rotating twin-screw extruder and cooling calender rolls to prepare a 4 m wide waterproof sheet, with an extruder operating temperature of 210 °C and a screw rotation speed of 300 rpm; the cooling calender rolls have a roll temperature of 55 °C and a roll diameter of 600 mm.

### Comparative Example 2

A waterproof sheet, the preparation method thereof includes:
Step S1: Adding 60 parts of a linear low-density polyethylene, 25 parts of an antioxidant and 15 parts of a light stabilizer into a high-speed mixer, mixing for 5 min, and stirring at 25 °C to prepare an antioxidant premix;
the antioxidant is a mixture of a phenolic antioxidant and a phosphite antioxidant in a weight ratio of 1:2, the phenolic antioxidant is antioxidant 2246, and the phosphite antioxidant is a mixture of tris(2,4-di-tert-butylphenyl) phosphite and distearyl pentaerythritol diphosphite; the linear low-density polyethylene and light stabilizer are the same as those in Example 1;
Step S2: Processing the antioxidant premix through an underwater pelletizer to prepare an antioxidant masterbatch, with a melt extrusion temperature of 195 °C and a rotation speed of 300 rpm;
Step S3: Adding 23 parts of an ethylene-vinyl acetate copolymer, 31 parts of an ultra-high molecular weight polyethylene, 24 parts of a modified polypropylene, 4 parts of silica particles, 4 parts of a carboxylic acid type compatibilizer, and 4 parts of an antioxidant masterbatch into a mixer, mixing for 10 min until uniform to prepare a sheet premix; where, except for the compatibilizer and antioxidant masterbatch, the rest are the same as those in Example 1;
Step S4: Processing the sheet premix through a counter-rotating twin-screw extruder and cooling calender rolls to prepare a 4 m wide waterproof sheet, with an extruder operating temperature of 210 °C and a screw rotation speed of 300 rpm; the cooling calender rolls have a roll temperature of 55 °C and a roll diameter of 600 mm.

### Comparative Example 3

A waterproof sheet, the preparation method thereof includes:
Step S1: Adding 60 parts of a linear low-density polyethylene, 25 parts of an antioxidant and 15 parts of a light stabilizer into a high-speed mixer, mixing for 5 min, and stirring at 25 °C to prepare an antioxidant premix;
the antioxidant is a mixture of a phenolic antioxidant and a phosphite antioxidant in a weight ratio of 1:2, the phenolic antioxidant is antioxidant 2246, and the phosphite antioxidant is a mixture of tris(2,4-di-tert-butylphenyl) phosphite and distearyl pentaerythritol diphosphite; the linear low-density polyethylene and light stabilizer are the same as those in Example 1;
Step S2: Processing the antioxidant premix through an underwater pelletizer to prepare an antioxidant masterbatch, with a melt extrusion temperature of 195 °C and a rotation speed of 300 rpm;
Step S3: Adding 23 parts of an ethylene-vinyl acetate copolymer, 31 parts of an ultra-high molecular weight polyethylene, 24 parts of a modified polypropylene, 16 parts of an ethylene-octene copolymer, 4 parts of a carboxylic acid type compatibilizer, and 4 parts of an antioxidant masterbatch into a mixer, mixing for 10 min until uniform to prepare a sheet premix; where, except for the compatibilizer and antioxidant masterbatch, the rest are the same as those in Example 1;
Step S4: Processing the sheet premix through a counter-rotating twin-screw extruder and cooling calender rolls to prepare a 4 m wide waterproof sheet, with an extruder operating temperature of 210 °C and a screw rotation speed of 300 rpm; the cooling calender rolls have a roll temperature of 55 °C and a roll diameter of 600 mm.

### Effect Example 1

The production rates of the 4 m wide waterproof sheets in Examples 1 to 6 and Comparative Examples 1 to 3 were obtained by the following method, and the results are shown in Table 1.

Production rate test method: for any roll of waterproof sheet, the production rate of the roll is obtained by the formula v=S/t, where S is the length of the roll of waterproof sheet and t is the preparation time of the roll of waterproof sheet;
The above steps are repeated to obtain the production rate of each roll of waterproof sheet, and the average of all production rates is taken as the final production rate.

TABLE 1
Production rate of 4 m wide waterproof sheets

| Test items | Production rate |
|---|---|
| Example 1 | 3.7 m/min |
| Example 2 | 4.3 m/min |
| Example 3 | 3.9 m/min |
| Example 4 | 4.0 m/min |
| Example 5 | 3.8 m/min |
| Example 6 | 3.7 m/min |
| Comparative Example 1 | 2.8 m/min |
| Comparative Example 2 | 2.7 m/min |
| Comparative Example 3 | 2.9 m/min |

It can be seen from Table 1 that the production rates of the 4 m wide waterproof sheets in Examples 1 to 6 are as high as 3.7 to 4.3 m/min.

### Effect Example 2

The products prepared in Examples 1 to 6 and Comparative Examples 1 to 3 were tested for tear strength, tensile strength at break, elongation at break, puncture strength, high-temperature puncture resistance and VA content, and the results are shown in Table 2.

The performance test indicators and methods are as follows: tear strength, tensile strength at break, elongation at break and puncture strength are tested according to the standard QCR562.1-2018; for high-temperature puncture resistance: the sample was first placed in an oven at 70 °C for 1 hour, and then the puncture test was performed in an environmental chamber at 70 °C; VA content was tested according to the standard method GB/T 30925-2014.

TABLE 2
Performance test results of products prepared
in each example and comparative example

| | Tensile | | | | High- | |
|---|---|---|---|---|---|---|
| | Strength | Elongation | Tear | Puncture | Temperature | VA |
| | at Break | at Break | Strength | Strength | Puncture | Content |
| Test Items | (MPa) | (%) | (kN/m) | (N) | Strength (N) | (wt/%) |
| Standard | ≥18 | ≥600% | ≥100 | ≥300 | ≥300 | ≥5 |
| Example 1 | 26 | 860 | 127 | 575 | 429 | 5.0 |
| Example 2 | 29 | 900 | 130 | 600 | 433 | 5.4 |
| Example 3 | 27 | 844 | 125 | 565 | 431 | 5.6 |
| Example 4 | 25 | 871 | 121 | 594 | 421 | 5.0 |
| Example 5 | 26 | 877 | 126 | 588 | 419 | 5.2 |
| Example 6 | 26 | 878 | 124 | 579 | 423 | 5.3 |
| Comparative | 23 | 660 | 126 | 485 | 322 | 5.4 |
| Example 2 | | | | | | |
| Comparative | 25 | 849 | 99 | 585 | 410 | 5.4 |
| Example 3 | | | | | | |
| Comparative | 22 | 630 | 101 | 549 | 405 | 5.4 |
| Example 3 | | | | | | |

It can be seen from Table 2 that the waterproof sheets obtained in Examples 1 to 6 of the present application have excellent mechanical properties. In addition, the addition of modified polypropylene has an enhancing effect on all properties of the material, with the greatest impact on puncture strength and high-temperature puncture resistance; the ethylene-octene copolymer has good compatibility with polyolefins and can effectively improve the tear strength of the material; the silica particles help increase the compatibility of various materials during processing, thereby improving the mechanical properties of the material.

What is claimed is:

1. A puncture-resistant and tear-resistant waterproof sheet, wherein the waterproof sheet is prepared by uniformly mixing various raw materials and then processing the mixture through a counter-rotating twin-screw extruder and cooling calender rolls;
the raw materials for the waterproof sheet comprise, in parts by weight, 15 to 35 parts of an ethylene-vinyl acetate copolymer, 20 to 40 parts of an ultra-high molecular weight polyethylene, 20 to 30 parts of a modified polypropylene, 10 to 25 parts of an ethylene-octene copolymer, 3 to 5 parts of silica particles, 3 to 5 parts of a compatibilizer, and 3 to 5 parts of an antioxidant masterbatch.

2. The puncture-resistant and tear-resistant waterproof sheet according to claim 1, wherein the ethylene-vinyl acetate copolymer has a vinyl acetate content of 15 wt % to 35 wt % and a melt flow rate of 5.8 to 6.5 g/10 min measured at 190 °C under a 2.16 kg load;
the ultra-high molecular weight polyethylene has a density of 0.920 to 0.969 g/cm³.

3. The puncture-resistant and tear-resistant waterproof sheet according to claim 1, wherein the modified polypropylene is a modified polypropylene comprising styrene-butadiene-styrene block copolymer segments; the silica particles have a particle diameter of 10 to 30 μm; the compatibilizer is a maleic anhydride grafted compatibilizer or a carboxylic acid type compatibilizer.

4. The puncture-resistant and tear-resistant waterproof sheet according to claim 1, wherein the ethylene-octene copolymer has a density of 0.901 to 0.920 g/cm³ and a melt flow rate of 0.80 to 1.10 g/10 min measured at 190 °C under a 2.16 kg load.

5. The puncture-resistant and tear-resistant waterproof sheet according to claim 1, wherein the raw materials of the antioxidant masterbatch comprise, in parts by weight, 50 to 70 parts of a linear low-density polyethylene, 20 to 30 parts of an antioxidant, and 10 to 20 parts of a light stabilizer;
the linear low-density polyethylene has a density of 0.918 to 0.923 g/cm³ and a melt flow rate of 0.60 to 1.30 g/10 min measured at 190 °C under a 2.16 kg load;
the light stabilizer is a hindered amine light stabilizer; the antioxidant is a mixture of a phenolic antioxidant and a phosphite antioxidant in a weight ratio of 1:2, the phenolic antioxidant is antioxidant 1010 or antioxidant 2246; the phosphite antioxidant is selected from one or both of tris(2,4-di-tert-butylphenyl) phosphite and distearyl pentaerythritol diphosphite.

6. A preparation method of the puncture-resistant and tear-resistant waterproof sheet according to claim 1, wherein the method comprises:
Step S1: Adding an antioxidant, a light stabilizer, and a linear low-density polyethylene into a high-speed mixer, and stirring the mixture at 25±5 °C to prepare an antioxidant premix, wherein the antioxidant is a mixture of a phenolic antioxidant and a phosphite antioxidant in a weight ratio of 1:2;
Step S2: Processing the antioxidant premix through an underwater pelletizer to prepare an antioxidant masterbatch;
Step S3: Adding the antioxidant masterbatch, an ethylene-vinyl acetate copolymer, an ultra-high molecular weight polyethylene, a modified polypropylene, an ethylene-octene copolymer, silica particles, and a compatibilizer into a mixer, and mixing uniformly to prepare a sheet premix;
Step S4: Processing the sheet premix through a counter-rotating twin-screw extruder and cooling calender rolls to achieve continuous production of a 4 m wide puncture-resistant and tear-resistant waterproof sheet at a rate of 3.7 to 4.3 m/min.

7. The preparation method of a puncture-resistant and tear-resistant waterproof sheet according to claim 6, wherein in step S1, the antioxidant, the light stabilizer, and the linear low-density polyethylene are mixed in the high-speed mixer for 5 min.

8. The preparation method of a puncture-resistant and tear-resistant waterproof sheet according to claim 6, wherein in step S2, the antioxidant premix is subjected to melt blending in the underwater pelletizer, the melt extrusion temperature is 190 to 200 °C, and the rotation speed is 200 to 350 rpm; the melt extrusion equipment is a counter-rotating twin-screw extruder.

9. The preparation method of a puncture-resistant and tear-resistant waterproof sheet according to claim 6, wherein in step S3, the antioxidant masterbatch, the ethylene-vinyl acetate copolymer, the ultra-high molecular weight polyethylene, the modified polypropylene, the ethylene-octene copolymer, the silica particles and the compatibilizer are mixed in the mixer for 10 min.

10. The preparation method of a puncture-resistant and tear-resistant waterproof sheet according to claim 6, wherein in step S4, the counter-rotating twin-screw extruder has an operating temperature of 200 to 220 °C and a screw rotation speed of 300 rpm;
the cooling calender rolls have a roll temperature of 55±5 °C and a roll diameter of 600 mm.
